(19) United States
(12) Patent Application Publication
(10) Pub. No.: US 2024/0169033 A1
(43) Pub. Date: May 23, 2024

(54) GENERATION OF IRRELEVANCY SCORES FOR INPUT TEXT

(71) Applicant: Vertex, Inc., King of Prussia, PA (US)

(72) Inventor: Lizaveta Dauhiala, Minsk (BY)

(21) Appl. No.: 18/058,242

(22) Filed: Nov. 22, 2022

(51) Int. Cl. G06K 9/62; G06N 20/00

(52) U.S. Cl. CPC G06K 9/6277; G06N 20/00

(57) ABSTRACT

Systems and methods are provided that include a processor executing a program to generate token sequences based on input text, generate an encoder output by inputting the token sequences into a multi-layer bidirectional transformer, linearly transform the encoder output and output a transformed relevant output and transformed irrelevant output, respectively, compute a relevance probability and a first irrelevance probability, respectively, by inputting the transformed relevant output and the transformed irrelevant output into a sigmoid function, the relevance probability being a probability that the token sequence belongs in the relevant classification group, the first irrelevance probability being a probability that the token sequence belongs in the irrelevant classification group, compute a second irrelevance probability by inputting the relevance probability and the first irrelevance probability into a tensor product formula, and generate and output an irrelevancy score for the input text based on the second irrelevance probability.

### BACKGROUND

In the machine learning field of text classification, sorting relevant and irrelevant information presents a significant challenge. One of the classic problems in Natural Language Processing (NLP) is to assign predefined categories to a given text sequence. Recent methods have made progress using various neural models to learn text representation, including convolutional models, recurrent models, and attention mechanisms. Though these methods are capable of many different text classification tasks, the quality of the text classification tasks is insufficient for some applications. One reason for this is that, when binary text classification tasks are performed, misclassifications frequently occur. As one particular example, tax researchers may be interested in sorting and classifying tax law articles into a relevant classification group and an irrelevant classification group, and many relevant tax law articles may be misclassified as irrelevant using current methods.

### SUMMARY

In view of the above, a computing system is provided, comprising a processor and memory of a computing device, the processor being configured to execute a program using portions of memory to receive input text; generate token sequences based on the input text; generate an encoder output by inputting the token sequences into a multi-layer bidirectional transformer to transform the token sequences into the encoder output, the multi-layer bidirectional transformer being trained using binary cross entropy loss on a set of ground truth token sequences which are labeled irrelevant for irrelevant text data which belongs in an irrelevant classification group, and labeled relevant for relevant text data which belongs in a relevant classification group; input the encoder output into a relevant linear function and an irrelevant linear function to linearly transform the encoder output, and output a transformed relevant output and a transformed irrelevant output, respectively; compute a relevance probability and a first irrelevance probability, respectively, by inputting the transformed relevant output and the transformed irrelevant output into a sigmoid function, the relevance probability being a probability that the token sequence belongs in the relevant classification group, the first irrelevance probability being a probability that the token sequence belongs in the irrelevant classification group; compute a second irrelevance probability by inputting the relevance probability and the first irrelevance probability into a tensor product formula; and generate and output an irrelevancy score for the input text based on the second irrelevance probability.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a schematic view of a computing system according to an example of the present disclosure.

FIG. 2 illustrates a detailed schematic view of the program of the computing system of FIG. 1.

FIG. 3 illustrates one example of an input text and graphical output of the program of FIGS. 1 and 2.

FIG. 4 is a flowchart of a method for generating and outputting an irrelevance score for a token sequence of an input text according to an example embodiment of the present disclosure.

FIG. 5 shows an example computing environment of the present disclosure.

### DETAILED DESCRIPTION

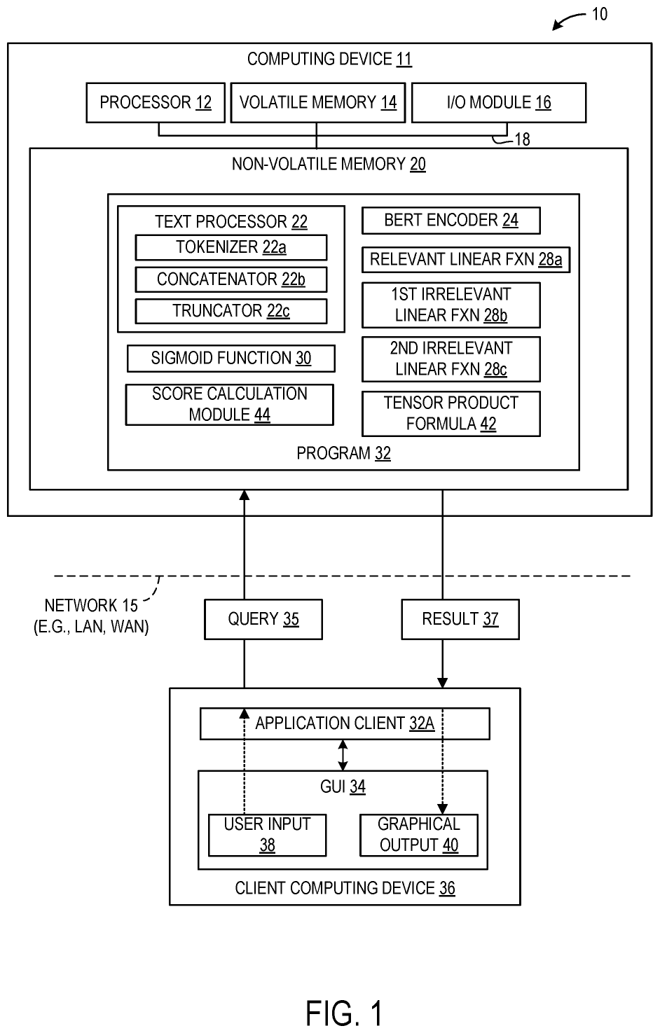

Referring to FIG. 1, a system 10 is provided, comprising a computing device 11 including a processor 12, an input/output module 16, volatile memory 14, and non-volatile memory 20 storing a program 32 comprising a text processor 22, a multi-layer bidirectional transformer 24, which is preferably a BERT (Bidirectional Encoder Representations from Transformers) encoder, a relevant linear function 28a, a first irrelevant linear function 28b, a second irrelevant linear function 28c, a sigmoid function 30, a tensor product formula 42, and a score calculation module 44. The text processor 22 includes a tokenizer 22a, a concatenator 22b, and a truncator 22c. A bus 18 may operatively couple the processor 12, the input/output module 16, and the volatile memory 14 to the non-volatile memory 20. Although the program 32 is depicted as hosted at one computing device 11, it will be appreciated that the program 32 may alternatively be hosted across a plurality of computing devices to which the computing device 11 is communicatively coupled via a network 15, including a client computing device 36 operatively coupled to the computing device 11. In some examples, the network 15 may take the form of a local area network (LAN), wide area network (WAN), wired network, wireless network, personal area network, or a combination thereof, and can include the Internet.

The system 10 comprises a processor 12 configured to store the program 32 in non-volatile memory 20. The non-volatile memory 20 retains instructions and stored data even in the absence of externally applied power, such as FLASH memory, a hard disk, read only memory (ROM), electrically erasable programmable memory (EEPROM), etc. The instructions include one or more programs, including program 32, and data used by such programs sufficient to perform the operations described herein. In response to execution by the processor 12, the instructions cause the processor 12 to execute the program 32 including the text processor 22, the BERT encoder 24, the relevant linear function 28a, the first irrelevant linear function 28b, the second irrelevant linear function 28c, the sigmoid function 30, the tensor product formula 42, and the score calculation module 44.

The processor 12 is a microprocessor that includes one or more of a central processing unit (CPU), a graphical processing unit (GPU), an application specific integrated circuit (ASIC), a system on chip (SOC), a field-programmable gate array (FPGA), a logic circuit, or other suitable type of microprocessor configured to perform the functions recited herein. The system 10 further includes volatile memory 14 such as random access memory (RAM), static random access memory (SRAM), dynamic random access memory (DRAM), etc., which temporarily stores data only for so long as power is applied during execution of programs.

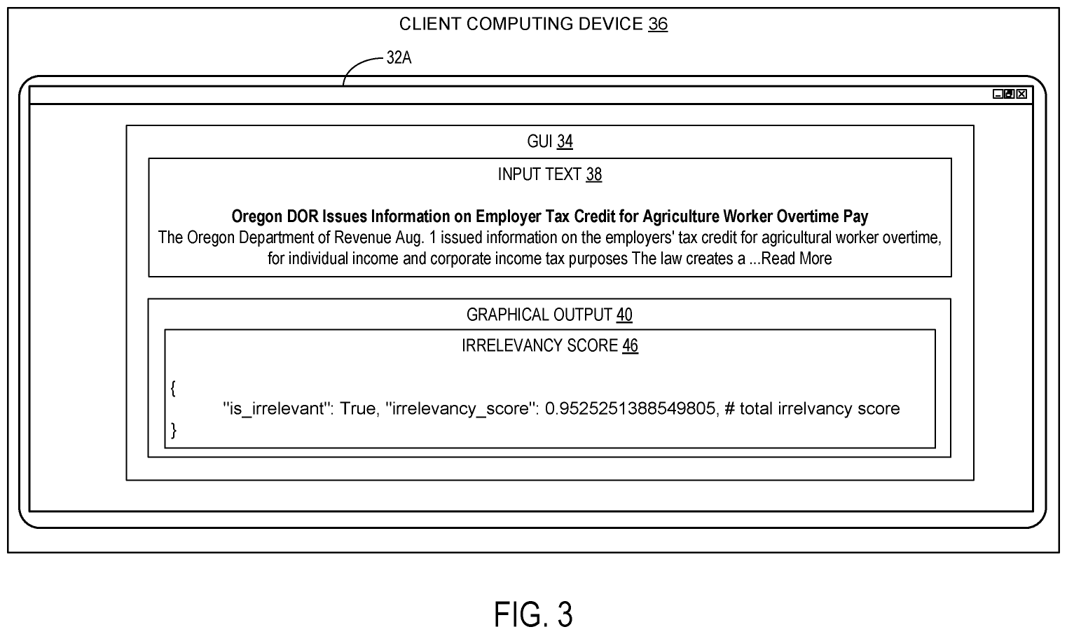

In one example, a user operating a client computing device 36 may send a query 35 to the computing device 11. As described further with reference to FIG. 3, the query 35 includes text data. The processor 12 of the computing device 11 is configured to receive the query 35 from the user and execute the program 32 to determine an appropriate score indicating how irrelevant the queried text data is for tax researchers. The processor 12 then returns a response 37 (query results) to the query 35 based on the determination that was made by the program 32, the response 37 containing a score that is a result of the determination that was made by the BERT encoder 24, the relevant linear function 28a, the first irrelevant linear function 28b, the second irrelevant linear function 28c, the sigmoid function 30, the tensor product formula 42, and the score calculation module 44.

The client computing device 36 may execute an application client 32A to send a query 35 to the computing device 11 upon detecting a user input 38, and subsequently receive the query results 37 from the computing device 11. The application client 32A may be coupled to a graphical user interface 34 of the client computing device 36 to display a graphical output 40 of the received query results 37.

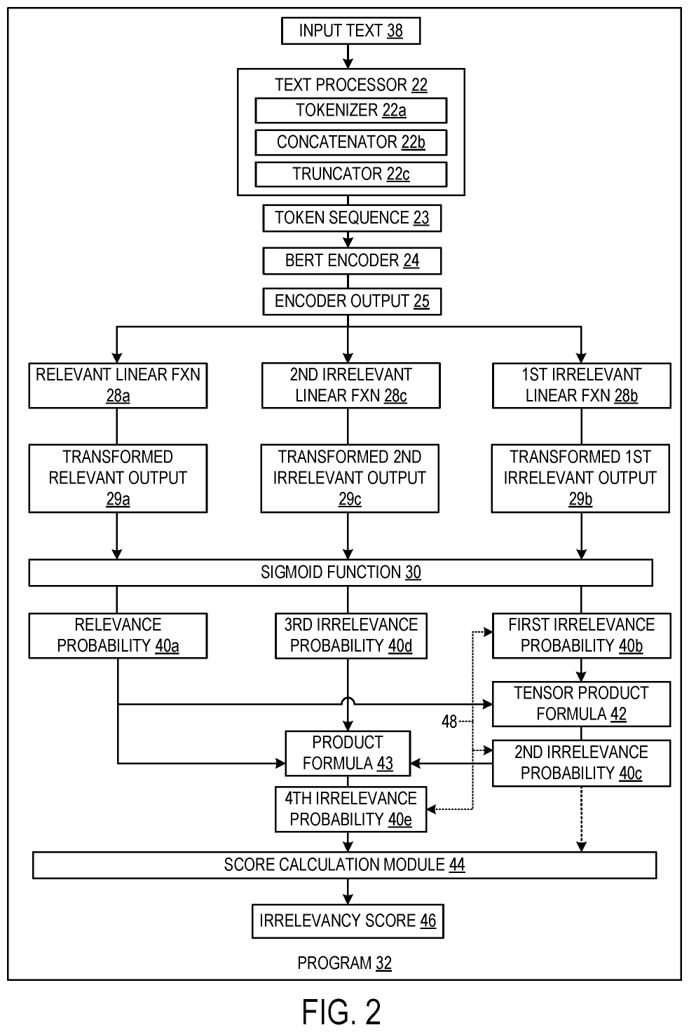

Referring to FIG. 2, a view of the program 32 including the text processor 22, the BERT encoder 24, the relevant linear function 28a, the first irrelevant linear function 28b, the second irrelevant linear function 28c, the sigmoid function 30, the tensor product formula 42, and the score calculation module 44 is depicted. The input text 38, which may include articles and other text data from various publications including legal databases, journals, papers, treatises, books, and guides, is processed by a text processor 22.

The text processor 22 comprises a tokenizer 22a, which converts the input text into tokens, a concatenator 22b, which concatenates the tokens into token sequences, and a truncator 22c which truncates the token sequences to a predetermined maximum length.

The first token of every token sequence may be a predetermined classification token ([CLS]). The final hidden state corresponding to this token may be used as the aggregate sequence representation for classification tasks. Token sequence pairs may be packed together into a single token sequence. The token sequences may be differentiated from each other by separating them with a predetermined separation token ([SEP], for example), or by adding a learned embedding, corresponding to each token sequence, to every token indicating which token sequence the token belongs to.

The BERT encoder 24 is a BERT model, or a transformer language model with a variable number of encoder layers and self-attention heads. Configured for text classification, the BERT encoder 24 may include 12 transformer blocks, 12 self-attention heads, and a hidden size of 768, for example. The BERT encoder 24 receives an input of a token sequence 23 up to the predetermined maximum length, and outputs a representation of the token sequence 23 in the form on an encoder output 25. For the text classification tasks, the BERT encoder 24 takes the final hidden state h of the first token [CLS] as the representation of the whole sequence. A simple softmax classifier is added to the top of the BERT encoder 24 to predict the probability of label c: p(c|h)=softmax (Wh), where W is the task-specific parameter matrix. All parameters of the BERT encoder 24 and W are fine-tuned jointly by maximizing the log-probability of the correct label. The BERT encoder 24 is trained using binary cross entropy loss on a set of ground truth token sequences which are labeled irrelevant for irrelevant text data and labeled relevant for relevant text data.

During the generation of the encoder output 25 by the BERT encoder 24, a dropout is configured to be performed on top of the predetermined classification token output representation, so that the output vectors corresponding to all tokens other than the predetermined separation token and/or the predetermined classification token are dropped, and only the outputs corresponding to the predetermined classification token and the predetermined separation token are encoded. The dropout probability is set to greater than 0.1, preferably in a range of 0.4 to 0.8, and more preferably to 0.5.

The encoder output 25 from the BERT encoder 24 is inputted in parallel into the relevant linear function 28a, the first irrelevant linear function 28b, and the second irrelevant linear function 28c, which apply linear transformations to the encoder output 25 to output a transformed relevant output 29a, a transformed first irrelevant output 29b, and a transformed second irrelevant output 29c, respectively. The predetermined classification token from the last hidden layer of the BERT encoder 24 may be passed to the relevant linear function 28a, the first irrelevant linear function 28b, and the second irrelevant linear function 28c. The respective transformed outputs 29a, 29b, 29c of the relevant linear function 28a, the first irrelevant linear function 28b, and the second irrelevant linear function 28c, respectively, are inputted into the sigmoid function 30.

The sigmoid function 30 performs a multi-label classification and computes a logistic sigmoid function of the elements of the encoder output 25 to determine the probability that a given token sequence 23 belongs to one of a plurality of classification groups. In one example, the program 32 is tailored for tax law researchers, so that articles and publications relating to tax law can be sorted according to relevancy and/or irrelevancy to tax law researchers. In this particular example, the tax researchers are interested in filtering out articles which contain only administrative tax information, income tax information, or property tax information, and do not mention any information about tax changes or supported imposition types. Therefore, the plurality of classification groups comprise a relevant classification group, a first irrelevant classification group, and a second irrelevant classification group.

The relevant classification group is for tax law articles which contain any tax information other than administrative tax information, income tax information, or property tax information. The first irrelevant classification group is for irrelevant tax law articles which contain only income tax information and/or property tax information, and do not mention any other tax information, including information about tax changes or supported imposition types. The second irrelevant classification group is for irrelevant tax law articles which contain only administrative tax information, and do not mention any other tax information. To calculate the relevance probability that a given token sequence 23 belongs in the relevant classification group, the encoder output 25 from the BERT encoder 24 is inputted into a relevant linear function 28a to linearly transform the encoder output 25 to compute the transformed relevant output 29a, which is inputted into the sigmoid function 30 to compute a relevance probability 40a that the token sequence 23 contains tax information other than administrative tax information, income tax information, or property tax information.

To calculate the first irrelevance probability 40b that the token sequence 23 belongs in the first irrelevant classification group, the encoder output 25 is inputted into the first irrelevant linear function 28b to linearly transform the encoder output 25 to compute a transformed first irrelevant output 29b, which is inputted into the sigmoid function 30 to compute a first irrelevance probability 40b. Then the following tensor product formula 42 is applied, inputting the relevance probability 40a and the first irrelevance probability 40b to compute the second irrelevance probability 40c: (1−RP)*(1−tensor product(1−FIP)), where RP stands for relevance probability 40a and FIP stands for first irrelevance probability 40b. First, a tensor product is returned for all elements in (1−FIP). Then one subtracted by the tensor product is multiplied by one subtracted by the relevance probability 40a to compute the second irrelevance probability 40c.

To calculate a third irrelevance probability 40d that the token sequence 23 belongs in the second irrelevant classification group, the encoder output 25 is inputted into the second irrelevant linear function 28c to linearly transform the encoder output 25 to compute a transformed second irrelevant output 29c, which is inputted into the sigmoid function 30 to compute the third irrelevance probability 40d. Then a product formula 43 is applied, inputting the relevance probability 40a, the second irrelevance probability 40c, and the third irrelevance probability 40d to compute a fourth irrelevance probability 40e: SIP+(RP*TIP), where SIP stands for the second irrelevance probability 40c, RP stands for the relevance probability 40a, and TIP stands for the third irrelevance probability 40d. In other words, the product of the relevance probability 40a and the third irrelevance probability 40d is calculated, and this product and the second irrelevance probability 40c are summed together to compute the fourth irrelevance probability 40e.

The fourth irrelevance probability 40e is subsequently inputted into the score calculation module 44, which generates and outputs an irrelevancy score 46 for the input text 38 including a classification of the token sequence 23 as a relevant token sequence or an irrelevant token sequence. When the score calculation module 44 is configured to categorize token sequences 23, thresholds for the fourth irrelevance probability 40e may be selected based on validation set metrics. For example, if the fourth irrelevance probability 40e is greater than a predetermined threshold, then the token sequence 23 may be categorized as an irrelevant token sequence. On the other hand, if the fourth irrelevance probability 40e is less than the predetermined threshold, then the token sequence 23 may be categorized as a relevant token sequence.

During training, a set of ground truth token sequences are appropriately labeled irrelevant for irrelevant text data and labeled relevant for relevant text data, for example, by human experts. In this example, the ground truth token sequences used in training are appropriately labeled first irrelevant for token sequences which contain only income tax information or property tax information and do not mention any other tax information, labeled second irrelevant for token sequences which contain only administrative tax information and do not mention any other tax information, and labeled relevant for token sequences which may contain tax changes or supported imposition types, and do not mention any other tax information, including administrative tax information, income tax information, or property tax information. These appropriately, manually labeled ground truth token sequences are used to train the BERT encoder 24.

In alternative embodiments, the second irrelevant linear function 28c and the second classification group may be omitted so that the second irrelevance probability 40c is used by the score calculation module 44 to generates and output the irrelevancy score 46. If the second irrelevance probability 40c is greater than a predetermined threshold, then the token sequence 23 may be categorized as an irrelevant token sequence. On the other hand, if the second irrelevance probability 40c is less than the predetermined threshold, then the token sequence 23 may be categorized as a relevant token sequence. The ground truth token sequences used in training would be appropriately labeled irrelevant for token sequences which contain only income tax information or property tax information and do not mention any other tax information such as information related to tax changes or information related to tax administration, and labeled relevant for token sequences which contain any tax information other than income tax information or property tax information.

To guide and fine-tune the learning for the BERT encoder 24 during training, a binary cross entropy loss 48 is calculated for the first irrelevance probability 40b, the second irrelevance probability 40c, and the fourth irrelevance probability 40e. The binary cross entropy loss 48 is weighted more if the token sequence 23 is classified as first irrelevant or second irrelevant, and weighted less if the token sequence 23 is classified as relevant. The binary cross entropy loss 48 is then applied to the BERT encoder 24.

Alternatively, in embodiments omitting the second irrelevant linear function 28c and the second classification group, to guide and fine-tune the learning for the BERT encoder 24 during training, a binary cross entropy loss 48 is calculated for the first irrelevance probability 40b and the second irrelevance probability 40c. The binary cross entropy loss 48 is weighted more if the token sequence 23 is classified as irrelevant, and weighted less if the token sequence 23 is classified as relevant. The binary cross entropy loss 48 is then applied to the BERT encoder 24.

FIG. 3 shows a schematic view of a program 32A, in which an input text 38 is inputted into a GUI 34, and in response an irrelevancy score 46 corresponding to the input text 38 is outputted on the GUI 34. In this example, the input text 38 relates to an Employer Tax Credit in the State of Oregon. The program 32A tokenizes this input text 38 into a token sequence and processes the token sequence to output the irrelevancy score 46, which may be in a JSON format as shown in FIG. 3. In this example, the input text 38 is classified as irrelevant (“is irrelevant”: True). The irrelevancy score is 0.95 in a range between zero and one.

Although the above example relates to tax law research, it will be appreciated that the program 32 may be alternatively adapted to be used in other situations where a user may classify a set of input text 38 into relevant and irrelevant classifications. Notably, the use of linear functions to compute relevance probabilities and irrelevance probabilities increases the accuracy of the classification of token sequences into relevant and irrelevant classifications using a BERT encoder trained using binary cross entropy loss on a set of ground truth token sequences which are labeled irrelevant for irrelevant text data and labeled relevant for relevant text data.

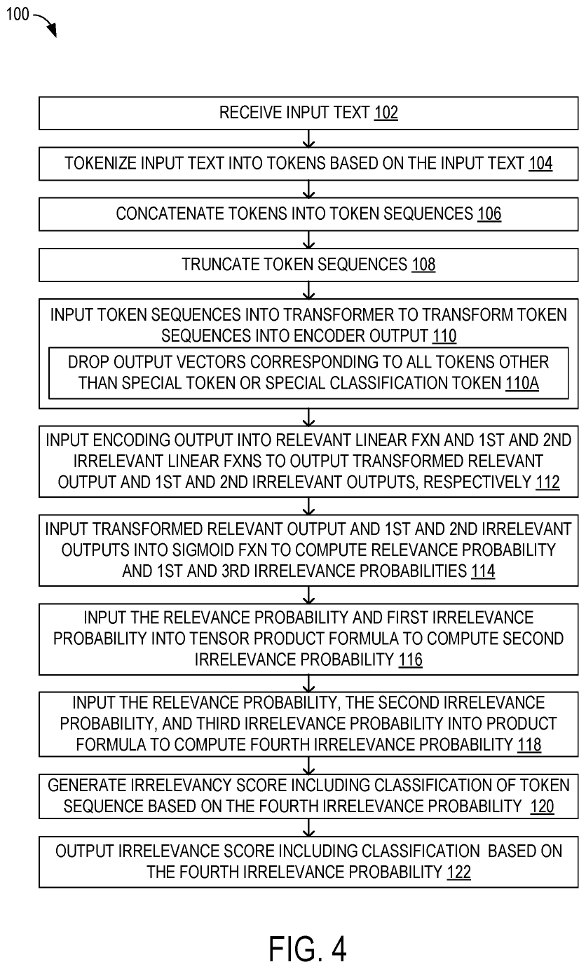

FIG. 4 illustrates a flowchart of a computerized method 100 for generating and outputting an irrelevance score for a token sequence of an input text. The following description of computerized method 100 is provided with reference to the software and hardware components described above and shown in FIGS. 1 to 3. It will be appreciated that computerized method 100 also may be performed in other contexts using other suitable hardware and software components.

At step 102, input text is received. At step 104, the input text is tokenized into tokens. At step 106, the tokens are concatenated into token sequences. At step 108, the token sequences are truncated. At step 110, the token sequences are received as input by a multi-layer bidirectional transformer to transform the token sequences into the encoder output, the multi-layer bidirectional transformer being trained using binary cross entropy loss on a set of ground truth token sequences which are labeled irrelevant for irrelevant text data which belongs in an irrelevant classification group, and labeled relevant for relevant text data which belongs in a relevant classification group. Step 110 includes a step 110A, at which output vectors corresponding to all tokens other than the predetermined separation token or the predetermined classification token are dropped.

At step 112, the encoder output is inputted into the relevant linear function, the first irrelevant linear function, and the second irrelevant linear function to linearly transform the encoder output and output a transformed relevant output, a transformed first irrelevant output, and a transformed second irrelevant output, respectively. At step 114, the transformed relevant output, the transformed first irrelevant output, and the transformed second irrelevant output are inputted into the sigmoid function to compute a relevance probability, a first irrelevance probability, and a third irrelevance probability, respectively. At step 116, the relevance probability and the first irrelevance probability are inputted into a tensor product formula to compute a second irrelevance probability. The tensor product formula is (1−RP)*(1−tensor product(1−FIP)), where RP stands for relevance probability and FIP stands for first irrelevance probability.

At step 118, the relevance probability, the second irrelevance probability, and the third irrelevance probability are inputted into a product formula to compute a fourth irrelevance probability. The product formula is SIP+(RP*TIP), where SIP stands for the second irrelevance probability, RP stands for relevance probability, and TIP stands for the third irrelevance probability. At step 120, an irrelevancy score including a classification of the token sequence is generated based on the fourth irrelevance probability. At step 122, the irrelevancy score for the input text, including the classification of the token sequence, is generated and outputted based on the fourth irrelevance probability.

The above-described system and method are provided for tax researchers to accurately filter out tax law articles with irrelevant information, which may be articles which contain administrative tax information, income tax information, or property tax information and do not mention any other tax information, and identify tax law articles with relevant information, which may be articles which mention tax changes or supported imposition types, and do not contain administrative tax information, income tax information, or property tax information, for example. This may help tax researchers save time spent on article analysis, decreasing cost and increasing the speed of information acquisition. These systems and methods may have particular advantage to tax researchers charged with assembling information on tax law in jurisdictions around the world.

In some embodiments, the methods and processes described herein may be tied to a computing system of one or more computing devices. In particular, such methods and processes may be implemented as a computer-application program or service, an application-programming interface (API), a library, and/or other computer-program product.

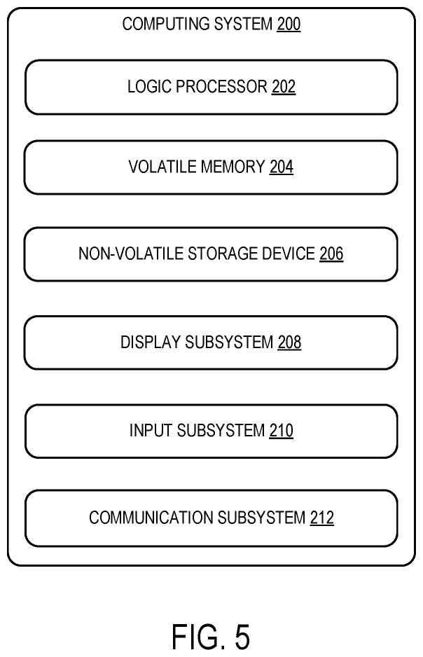

FIG. 5 schematically shows a non-limiting embodiment of a computing system 200 that can enact one or more of the methods and processes described above. Computing system 200 is shown in simplified form. Computing system 200 may embody the computing device 11 and the client computing device 36 described above and illustrated in FIGS. 1-3, respectively. Computing system 200 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 200 includes a logic processor 202 volatile memory 204, and a non-volatile storage device 206. Computing system 200 may optionally include a display sub system 208, input sub system 210, communication sub system 212, and/or other components not shown in FIG. 5.

Logic processor 202 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 202 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 206 includes one or more physical devices configured to hold instructions executable by the logic processors to implement the methods and processes described herein. When such methods and processes are implemented, the state of non-volatile storage device 206 may be transformed—e.g., to hold different data.

Non-volatile storage device 206 may include physical devices that are removable and/or built in. Non-volatile storage device 206 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 206 may include nonvolatile, dynamic, static, read/write, read-only, sequential-access, location-addressable, file-addressable, and/or content-addressable devices. It will be appreciated that non-volatile storage device 206 is configured to hold instructions even when power is cut to the non-volatile storage device 206.

Volatile memory 204 may include physical devices that include random access memory. Volatile memory 204 is typically utilized by logic processor 202 to temporarily store information during processing of software instructions. It will be appreciated that volatile memory 204 typically does not continue to store instructions when power is cut to the volatile memory 204.

Aspects of logic processor 202, volatile memory 204, and non-volatile storage device 206 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 200 typically implemented in software by a processor to perform a particular function using portions of volatile memory, which function involves transformative processing that specially configures the processor to perform the function. Thus, a module, program, or engine may be instantiated via logic processor 202 executing instructions held by non-volatile storage device 206, using portions of volatile memory 204. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 208 may be used to present a visual representation of data held by non-volatile storage device 206. The visual representation may take the form of a graphical user interface (GUI). As the herein described methods and processes change the data held by the non-volatile storage device, and thus transform the state of the non-volatile storage device, the state of display subsystem 208 may likewise be transformed to visually represent changes in the underlying data. Display subsystem 208 may include one or more display devices utilizing virtually any type of technology. Such display devices may be combined with logic processor 202, volatile memory 204, and/or non-volatile storage device 206 in a shared enclosure, or such display devices may be peripheral display devices.

When included, input subsystem 210 may comprise or interface with one or more user-input devices such as a microphone, camera, keyboard, mouse, or touch screen. The microphone may be configured to supply input to a speech recognition module.

When included, communication subsystem 212 may be configured to communicatively couple various computing devices described herein with each other, and with other devices. Communication subsystem 212 may include wired and/or wireless communication devices compatible with one or more different communication protocols. In some embodiments, the communication subsystem may allow computing system 200 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

It will be appreciated that “and/or” as used herein refers to the logical disjunction operation, and thus A and/or B has the following truth table.

| A | B | A and/or B |
|---|---|---|
| T | T | T |
| T | F | T |
| F | T | T |
| F | F | F |

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system, comprising:
a processor and memory of a computing device, the processor being configured to execute a program using portions of memory to:
receive input text;
generate token sequences based on the input text;
generate an encoder output by inputting the token sequences into a multi-layer bidirectional transformer to transform the token sequences into the encoder output, the multi-layer bidirectional transformer being trained using binary cross entropy loss on a set of ground truth token sequences which are labeled irrelevant for irrelevant text data which belongs in an irrelevant classification group, and labeled relevant for relevant text data which belongs in a relevant classification group;
input the encoder output into a relevant linear function and an irrelevant linear function to linearly transform the encoder output, and output a transformed relevant output and a transformed irrelevant output, respectively;
compute a relevance probability and a first irrelevance probability, respectively, by inputting the transformed relevant output and the transformed irrelevant output into a sigmoid function, the relevance probability being a probability that the token sequence belongs in the relevant classification group, the first irrelevance probability being a probability that the token sequence belongs in the irrelevant classification group;
compute a second irrelevance probability by inputting the relevance probability and the first irrelevance probability into a tensor product formula; and
generate and output an irrelevancy score for the input text based on the second irrelevance probability.

2. The computing system of claim 1, wherein
the token sequences are generated so that a first token of every token sequence is configured to be a predetermined classification token; and
the token sequences are separated by a predetermined separation token, or a learned embedding corresponding to each token sequence is added to each token of the token sequence.

3. The computing system of claim 2, wherein in the multi-layer bidirectional transformer, a dropout is configured to be performed in which output vectors corresponding to all tokens other than the predetermined separation token and/or the predetermined classification token are dropped, and only the output corresponding to the predetermined classification token and the predetermined separation token are encoded.

4. The computing system of claim 1, wherein
the irrelevant classification group is a first irrelevant classification group;
the irrelevant linear function is a first irrelevant linear function;
the transformed irrelevant output is a transformed first irrelevant output;
the multi-layer bidirectional transformer is trained using binary cross entropy loss on the set of ground truth token sequences which are labeled first irrelevant for irrelevant text data which belongs in the first irrelevant classification group, and labeled second irrelevant for irrelevant text data which belongs in a second irrelevant classification group;
the encoder output is inputted into the first irrelevant linear function, and a second irrelevant linear function to linearly transform the encoder output, and output the transformed first irrelevant output and a transformed second irrelevant output, respectively;
a third irrelevance probability is computed by inputting the transformed second irrelevant output into the sigmoid function, the third irrelevance probability being a probability that the token sequence belongs in the second irrelevant classification group;
a fourth irrelevance probability is computed by inputting the relevance probability, the first irrelevance probability, and the third irrelevance probability into a product formula;
the product formula is SIP+(RP*TIP), where SIP stands for the second irrelevance probability, RP stands for the relevance probability, and TIP stands for the third irrelevance probability; and
the irrelevancy score for the input text is generated and outputted based on the fourth irrelevance probability.

5. The computing system of claim 1, wherein the tensor product formula is (1−RP)*(1−tensor product(1−FIP)), where RP stands for relevance probability and FIP stands for first irrelevance probability.

6. The computing system of claim 1, wherein the binary cross entropy loss is calculated for the first irrelevance probability and the second irrelevance probability.

7. The computing system of claim 1, wherein the sigmoid function computes a logistic sigmoid function of elements of the encoder output to determine the relevance probability, the first irrelevance probability, and the second irrelevance probability.

8. The computing system of claim 1, wherein the irrelevancy score includes a classification of the token sequence as relevant or irrelevant based on the second irrelevance probability.

9. The computing system of claim 8, wherein the token sequence is categorized as irrelevant if the second irrelevance probability is greater than a predetermined threshold.

10. The computing system of claim 1, wherein the multi-layer bidirectional transformer is a BERT (Bidirectional Encoder Representations from Transformers) encoder.

11. A method comprising steps to:
receive input text;
generate token sequences based on the input text;
generate an encoder output by inputting the token sequences into a multi-layer bidirectional transformer to transform the token sequences into the encoder output, the multi-layer bidirectional transformer being trained using binary cross entropy loss on a set of ground truth token sequences which are labeled irrelevant for irrelevant text data which belongs in an irrelevant classification group, and labeled relevant for relevant text data which belongs in a relevant classification group;
input the encoder output into a relevant linear function and an irrelevant linear function to linearly transform the encoder output, and output a transformed relevant output and a transformed irrelevant output, respectively;
compute a relevance probability and a first irrelevance probability, respectively, by inputting the transformed relevant output and the transformed irrelevant output into a sigmoid function, the relevance probability being a probability that the token sequence belongs in the relevant classification group, the first irrelevance probability being a probability that the token sequence belongs in the irrelevant classification group;
compute a second irrelevance probability by inputting the relevance probability and the first irrelevance probability into a tensor product formula; and
generate and output an irrelevancy score for the input text based on the second irrelevance probability.

12. The method of claim 11, wherein
the token sequences are generated so that a first token of every token sequence is configured to be a predetermined classification token; and
the token sequences are separated by a predetermined separation token, or a learned embedding corresponding to each token sequence is added to each token of the token sequence.

13. The method of claim 12, wherein in the multi-layer bidirectional transformer, a dropout is performed in which output vectors corresponding to all tokens other than the predetermined separation token and/or the predetermined classification token are dropped, and only the output corresponding to the predetermined classification token and the predetermined separation token are encoded.

14. The method of claim 11, wherein
the irrelevant classification group is a first irrelevant classification group;
the irrelevant linear function is a first irrelevant linear function;
the transformed irrelevant output is a transformed first irrelevant output;
the multi-layer bidirectional transformer is trained using binary cross entropy loss on the set of ground truth token sequences which are labeled first irrelevant for irrelevant text data which belongs in the first irrelevant classification group, and labeled second irrelevant for irrelevant text data which belongs in a second irrelevant classification group;
the encoder output is inputted into the first irrelevant linear function, and a second irrelevant linear function to linearly transform the encoder output, and output the transformed first irrelevant output and a transformed second irrelevant output, respectively;
a third irrelevance probability is computed by inputting the transformed second irrelevant output into the sigmoid function, the third irrelevance probability being a probability that the token sequence belongs in the second irrelevant classification group;
a fourth irrelevance probability is computed by inputting the relevance probability, the first irrelevance probability, and the third irrelevance probability into a product formula;
the product formula is SIP+(RP*TIP), where SIP stands for the second irrelevance probability, RP stands for the relevance probability, and TIP stands for the third irrelevance probability; and
the irrelevancy score for the input text is generated and outputted based on the fourth irrelevance probability.

15. The method of claim 11, wherein the tensor product formula is (1−RP)*(1−tensor product (1−FIP)), where RP stands for relevance probability and FIP stands for first irrelevance probability.

16. The method of claim 11, wherein the binary cross entropy loss is calculated for the first irrelevance probability and the second irrelevance probability.

17. The method of claim 11, wherein the sigmoid function computes a logistic sigmoid function of elements of the encoder output to determine the relevance probability, the first irrelevance probability, and the second irrelevance probability.

18. The method of claim 11, wherein the irrelevancy score includes a classification of the token sequence as relevant or irrelevant based on the second irrelevance probability.

19. The method of claim 18, wherein the token sequence is categorized as irrelevant if the second irrelevance probability is greater than a predetermined threshold.

20. A computing system for classifying tax law articles, the computing system comprising:
a processor and memory of a computing device, the processor being configured to execute a program using portions of memory to:
receive input text from the tax law articles;
generate token sequences based on the input text;
generate an encoder output by inputting the token sequences into an encoder to transform the token sequences into the encoder output, the encoder being trained using binary cross entropy loss on a set of token sequences which are labeled with ground truth labels as first irrelevant for irrelevant text data which belongs in a first irrelevant classification group for irrelevant tax law articles which contain only income tax information or property tax information and no other tax information, labeled with ground truth labels as second irrelevant for irrelevant text data which belongs in a second irrelevant classification group for irrelevant tax law articles which contain only administrative tax information and no other tax information, and labeled with ground truth labels as relevant for relevant text data which belongs in a relevant classification group for relevant tax law articles which contain tax information other than administrative tax information, income tax information, or property tax information;
input the encoder output into a relevant linear function, a first irrelevant linear function, and a second irrelevant linear function to linearly transform the encoder output, and output a transformed relevant output, a transformed first irrelevant output, and a transformed second irrelevant output, respectively;
compute a relevance probability, a first irrelevance probability, and a third irrelevance probability, respectively, the relevance probability being a probability that the token sequence belongs in the relevant classification group, the first irrelevance probability being a probability that the token sequence belongs in the first irrelevant classification group, and the third irrelevance probability being a probability that the token sequence belongs in the second irrelevant classification group;
compute a second irrelevance probability by inputting the relevance probability and the first irrelevance probability into a tensor product formula;
compute a fourth irrelevance probability by inputting the relevance probability, the first irrelevance probability, and the third irrelevance probability into a product formula; and
generate and output an irrelevancy score for the input text based on the fourth irrelevance probability.
